(19) United States
(12) Patent Application Publication
(10) Pub. No.: US 2008/0248800 A1
(43) Pub. Date: Oct. 9, 2008

(54) Managing handoffs between overlaid networks

(75) Inventor: Louay Jalloul, Santa Clara, CA (US)

Correspondence Address: Beceem Communications, Inc., P.O. Box 6585, Santa Clara, CA, 95056-6585, US

(73) Assignee: Beceem Communications, Inc.

(21) Appl. No.: 11/784,078

(22) Filed: Apr. 5, 2007

(51) Int. Cl. H04Q 7/20

(52) U.S. Cl. 455/433

(57) ABSTRACT

A method and apparatus of managing a subscriber handoff between types of wireless networks is disclosed. The method includes the subscriber maintaining a wireless connection with a first wireless network. The subscriber simultaneously monitors availability of a second wireless network during open time slots of frames of transmission scheduling of the subscriber. The subscriber activates communication support circuitry for supporting a wireless connection to the second wireless network, if the second wireless network is detected to be available.

### FIELD OF THE INVENTION

The invention relates generally to wireless communications. More particularly, the invention relates to a method and apparatus for managing handoffs between overlaid networks.

### BACKGROUND OF THE INVENTION

Wireless communication technologies are rapidly evolving and being deployed. In some situations, it is possible to obtain wireless connections to multiple (for example, 3G, WiMAX and GSM) wireless networks at a given location. However, at the given location, one of the types of networks may provide a better wireless connection as determined by a better quality of service (QoS) or signal to noise ratio (SNR). Additionally, one type of network may provide better support of a type of data communication.

Generally, a subscriber device of a wireless network user can only communicate with one type of wireless network at a time. Therefore, the user is not able to take advantage of a better connection provided by a wireless network that the subscriber device of the user is not connected to. Additionally, the subscriber unit cannot adaptively select which wireless network to connect to, based on the type of data being transmitted between the subscriber device and the wireless network.

A subscriber can simultaneously communicate with multiple networks if the subscriber constantly powers electronic circuitry required to support the multiple network. However, subscribers are typically battery power units, and it is undesirable to provide continuous power to circuitry required to simultaneously support multiple networks. Without powering multiple network support circuitry, if the subscriber unit changes the type of wireless network it is connected to, the communication between the subscriber unit and the wireless network is disrupted. That is, the communication must be halted for a period of time while the subscriber initiates the connection to the new type of wireless network.

It is desirable for a low-power subscriber unit to monitor existence of multiple types of wireless networks and select the most desirable of the wireless network. It is additionally desirable that communications with the networks be minimally impacted while monitoring for network availability.

### SUMMARY OF THE INVENTION

An embodiment of the invention includes a method of managing a subscriber handoff between types of wireless networks. The method includes the subscriber maintaining a wireless connection with a first wireless network. The subscriber simultaneously monitors availability of a second wireless network during open time slots of frames of transmission scheduling of the subscriber. The subscriber activates communication support circuitry for supporting a wireless connection to the second wireless network, if the second wireless network is detected to be available.

Another embodiment of the invention includes a method of a subscriber unit managing wireless hand-off from a WiMAX network to a 3G network. The method includes the subscriber maintaining a wireless connection with WiMAX network. The subscriber simultaneously monitoring availability of a 3G network during open time slots of frames of transmission scheduling of the subscriber. The subscriber activates communication support circuitry for supporting a wireless connection to the 3G network, if the 3G network is detected to be available.

Another embodiment of the invention includes a method of a method of a subscriber unit managing wireless hand-off from a 3G network to a WiMAX network. The method includes the subscriber maintaining a wireless connection with 3G network. The subscriber simultaneously monitors availability of a WiMAX network during open time slots of frames of transmission scheduling of the subscriber. The subscriber activates communication support circuitry for supporting a wireless connection to the WiMAX network, if the WiMAX network is detected to be available.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows cells of a WiMAX network overlaying cells of a 3G network.

FIG. 2 shows a subscriber simultaneously receiving transmission signals from two different types of networks.

FIG. 3 shows an example of a WiMAX MAC scheduling frame.

FIG. 4 shows an example of a compressed CDMA scheduling frame.

FIG. 5 is a flow chart that includes steps of an example of a method of a multiple network subscriber monitoring wireless network availability.

FIG. 6 is a flow chart showing steps of one example of a method of a subscriber unit managing wireless hand-off from a WiMAX network to a 3G network.

FIG. 7 is a flow chart that includes steps of an example of a method of a subscriber unit managing wireless hand-off from a 3G network to a WiMAX network.

FIG. 8A shows an embodiment of receiver front-end circuitry of a multiple network subscriber.

FIG. 8B shows another embodiment of receiver front-end circuitry of a multiple network subscriber.

FIG. 9 shows an embodiment of receive signal correlation circuitry within a multiple network subscriber.

### DETAILED DESCRIPTION

Method and apparatuses for handoff between wireless network types are disclosed. Embodiments of the methods and apparatuses provide simultaneous wireless communication with a first wireless network type while monitoring the availability of other wireless network types. The embodiments described can conserve power by not requiring support circuitry for each of the different networks to be continuously powered.

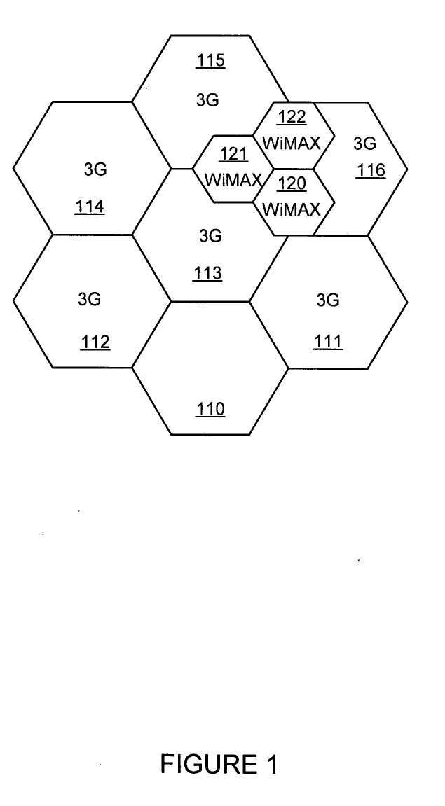

FIG. 1 shows an example of cells of a WiMAX network spatially overlaying cells of a 3G network. As shown, several 3G wireless network cells 110, 111, 112, 113, 114, 115, 116 provide 3G wireless access over a network coverage area as determined by the number and coverage areas of each of the 3G wireless network cells 110, 111, 112, 113, 114, 115, 116.

Also, as shown, several WiMAX network cells 120, 121, 122 provide WiMAX wireless access over a network coverage area as determined by the number and coverage areas of each of the WiMAX network cells 120, 121, 122. The coverage areas of the 3G cells 113, 115, 116 and the WiMAX cells 120, 121, 122 overlap. The area located within the overlapping region provides dual coverage of the two wireless network types.

An embodiment of a multiple network subscriber (user) can simultaneously receive communication signals from either wireless network. This allows the maintenance of communication with one of the wireless networks while detecting the availability of another wireless network. Because the maintenance of one wireless network and detection of another wireless network can be performed simultaneously, a handoff between the two networks can, be minimally disruptive. That is, wireless communications between the subscriber and the networks does not have to be interrupted during the transition from one network to the other.

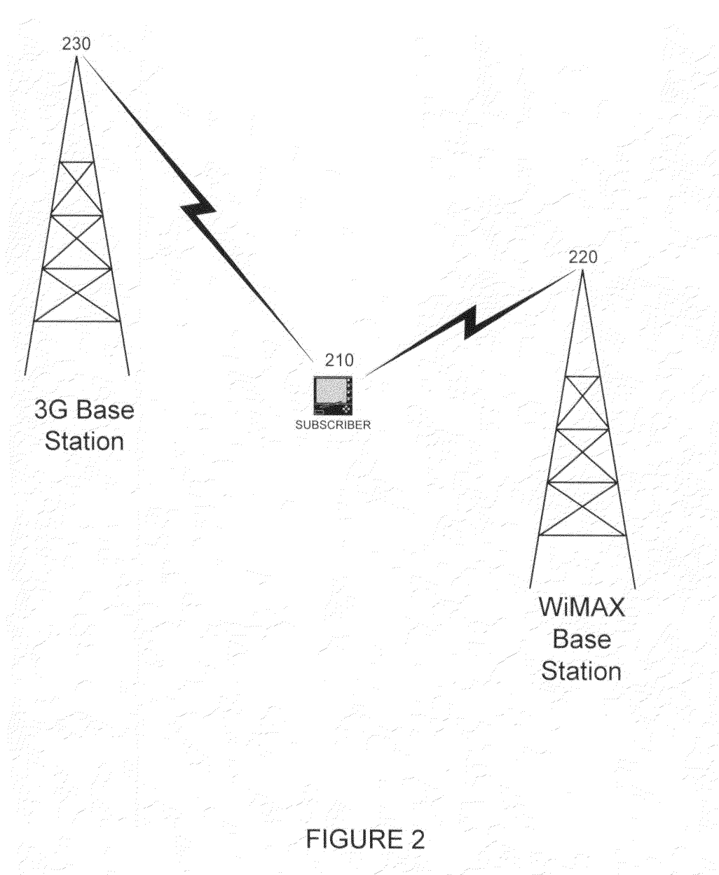

FIG. 2 shows an example of a subscriber 210 simultaneously receiving transmission signals from two different types of networks. A WiMAX base station 220 provides WiMAX network connection capability, and a 3G base station 230 provides 3G network connection capability. As will be described, WiMAX communications include a TDD frame structure, that can allows the subscriber 210 to monitor availability of another wireless network (such as, 3G or GSM wireless networks) while maintaining a WiMAX wireless communication. That is, monitoring of the other network can be performed simultaneous with WiMAX transmissions between the subscriber 210 and the WiMAX base station 220. Additionally, as will be described, 3G wireless communications also includes a mode (compressed mode) in which a TDD frame structure can be utilized to allow the subscriber 210 to monitor availability of another wireless network (such as, WiMAX) while maintaining a 3G wireless connection.

The methods for simultaneous connection of a subscriber with a first type of wireless network while monitoring a second type of wireless network, allows for a seamless handoff from the first wireless network to the second wireless network. The subscriber can monitor the availability of the second type of network during open slots of a TDD frame of either a WiMAX frame, or during an open slot of a 3G compressed frame. If the subscriber detects the presence of the second type of network, the subscriber can switch over to communicating with the second type of network. The switch is driven by the subscriber, and can be made without causing the subscriber to experience down time in which the subscriber is not communicating with at least one of the wireless networks. That is, the handoff from the first type of wireless network to the second type of wireless network can be uninterrupted. Additionally, because the monitoring of the second type of network is not continuous, support circuitry for communicating with the second network does not have to be continuously powered, thereby reducing the amount of power consumed.

The decision by the subscriber to switch can be based on one or a combination of other factors. For example, the quality of wireless connection provided by the second type of network, or the ability of the second type of network to handle the type of communication (for example, data, voice or video) of the subscriber can aid in the decision. Factors that can be considered include measured interference, received signal strength, SNR, SNIR, QoS, bit error rate (BER) or packet error rate (PER).

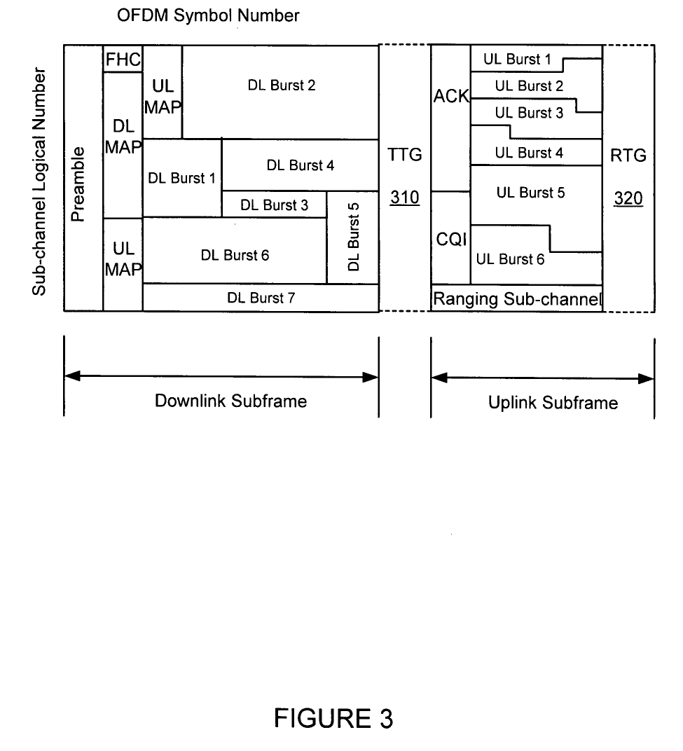

FIG. 3 shows an example of a WiMAX frame. As shown, the WiMAX frame includes within a downlink sub-frame, a preamble, an FCH, a DL MAP, DL Bursts, and within an uplink sub-frame, an UL MAP, an ACK, a CQI, and a Ranging Sub-channel. The preamble includes a set of tones/sub-carriers to help the subscriber synchronize to the WiMAX network. The FCH (frame control header) provides information about frame attributes. The DL MAP (downlink map) is a control field that includes modulation and coding formats as well as burst specific information to the user. The DL (downlink) burst provides downlink information scheduled to the user. The UL MAP (uplink map) is a control field that includes modulation and coding formats as well as burst specific information to the user. The ACK (acknowledgment field) indicates that the uplink packet transmitted by the subscriber is received correctly at the base station. The CQI (channel quality indicator) is a feedback channel from the subscriber to the base station, and provides a measure of the SNR of signals received by the subscriber. The ranging sub-channel is a control channel that allows the subscriber to synchronize to the network periodically or upon initial network entry.

As shown, a TTG (Transmit to receive transition gap) 310 occurs after the downlink subframe, and a RTG (Receive to transmit transition gap) 320 occurs after the uplink subframe. The TTG 310 and the RTG 320 provide time slots in which no WiMAX communication is occurring between the subscriber unit and a WiMAX base station. The time slots can be utilized to check the availability of a different type of wireless network without having to disrupt the transmission and reception of WiMAX communications.

Another embodiment includes checking the availability of other types of networks during both the open time slots (for example, TTG and RTG) and during the uplink sub-frame.

For an exemplary WiMAX system, the downlink (DL) sub-frame includes 34 symbols and has a time duration of 3.428 milliseconds. The uplink (UL) sub-frame includes 15 symbols and has a time duration of 1.512 milliseconds. An exemplary TTG provides a guard time of 121.2 microseconds between the downlink sub-frame and the uplink sub-frame. An exemplary RTG provides a guard time of 40.4 microseconds between the uplink sub-frame and the downlink sub-frame. As previously stated, these guard times (TTG and RTG) can be utilized to monitor and detect the presence of another type of wireless network, for example, a 3G wireless network.

For an embodiment in which the subscriber monitors the other network during uplink, TTG and RTG of a WiMAX frame, the time allowed for monitoring is 1.512+121.2+40.4 microseconds. For a 3G system having a clock rate of 3.84 Mcps, a chip duration is 260 nanoseconds. Therefore, the monitoring period covers approximately 3.84*(1512+40+161.6)=6581 3G system chips.

Typical 3G dispreading lengths can be 1024 clock chips for achieving high detection probability (greater than 90% correct) and low probability of a false detection (less than 0.1%). A single WiMAX radio frame is approximately 5 milliseconds, enabling the subscriber to collect all 1024 chips required for detection of a 3G network.

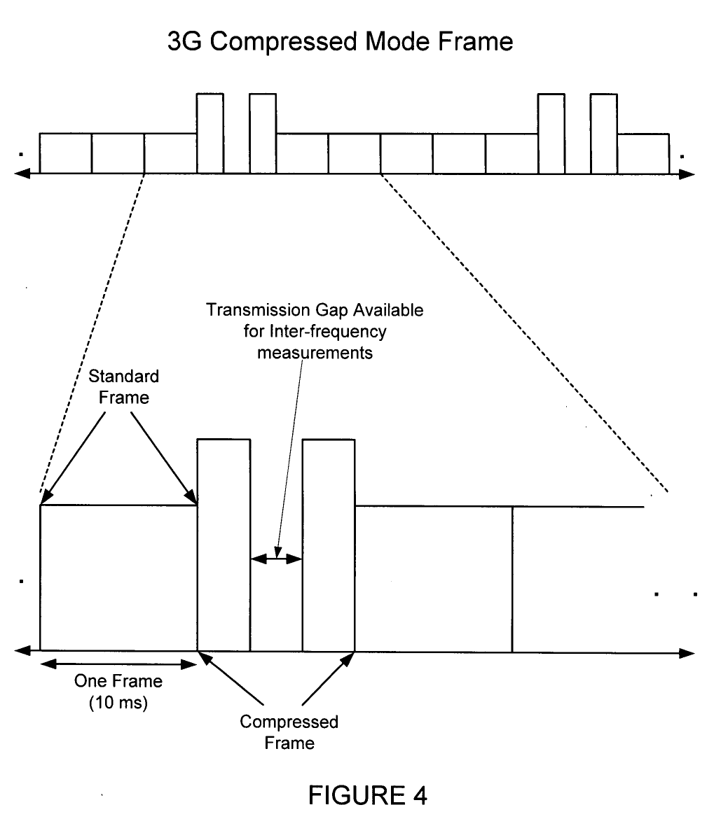

FIG. 4 shows an example of a compressed CDMA scheduling frame. A standard CDMA scheduling frame may not include time slots that are available for allowing a subscriber unit to monitor and detect that availability of another type of wireless network, such as, a WiMAX wireless network. However, CDMA includes a compressed mode, in which a time slot is available for the subscriber unit to monitor and detect the present of another type of wireless network.

FIG. 4 shows standard frames, and exemplary compressed frames. As shown, the compressed frames have an increased instantaneous power. The increased instantaneous signal power of the compressed frames, maintains signal quality (for example, bit error rate (BER), block error rate, SNR) compared to the standard frames, when subjected to processing. The amount in which the signal power is increased depends on how much the actual transmission time is decreased for the compressed frame.

The selection of which frame are to be compressed is typically controlled by the network. The compressed frames can occur periodically, or the compressed frames can be requested or demanded. The rate and type of compressed frame is generally variable, and typically depends on the environment of the network, and measurement requirements.

An exemplary 3G frame is 10 ms long. When in compressed mode, the information typically transmitted within a 10 ms frame is compressed in time. The time reduction can be achieved by reducing the spreading factor by, for example, two, and through higher layer scheduling. The time reduction in transmission required for the compressed mode can be obtained through the described methods in both the downlink and the uplink. Generally, the maximum idle length (Transmission gap available for monitoring another network) is 7 slots out of 15 slots of a 10 ms frame.

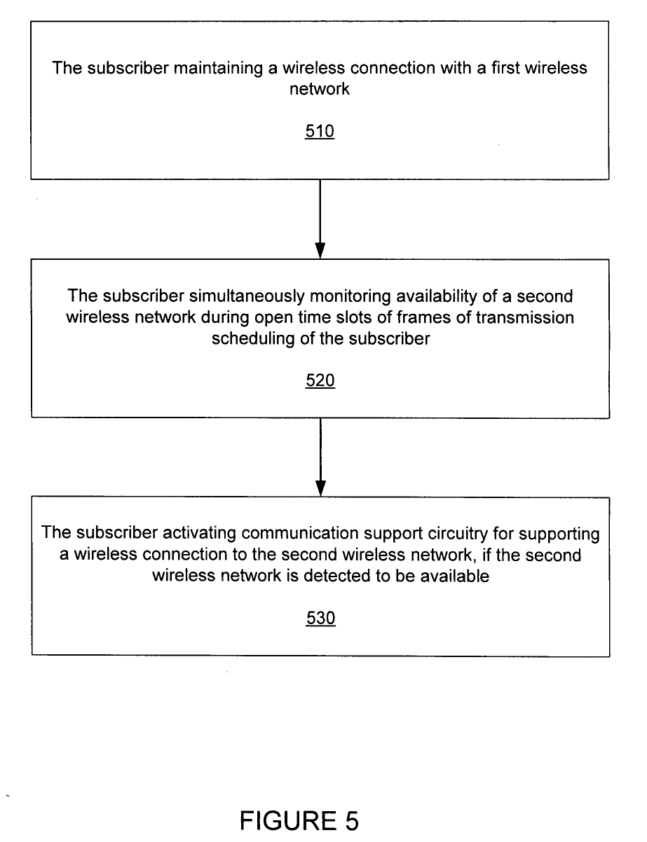

FIG. 5 is a flow chart that includes steps of an example of a method of a multiple network subscriber monitoring wireless network availability. A first step 510 of the method includes the subscriber maintaining a wireless connection with a first wireless network. A second step 520 includes the subscriber simultaneously monitoring availability of a second wireless network during open time slots of frames of transmission scheduling of the subscriber. A third step 530 includes the subscriber activating communication support circuitry for supporting a wireless connection to the second wireless network, if the second wireless network is detected to be available.

As previously described, examples of the first and second network include WiMAX, 3G or GSM networks. For voice communications, a 3G network may be preferred, and the subscriber may decide to switch to, or maintain wireless connection to the 3G network if the wireless communication includes voice communication. For data communication, a WiMAX network may be preferred, and the subscriber may decide to switch to, or maintain wireless connection to the WiMAX network if the wireless communication includes data communication.

One example of an embodiment of the subscriber detecting the presence of the second type of network includes the subscriber receiving signals of the second type of network, and verifying the signals are transmitted from the second type of network. As will be described, the signals can be verified, for example, by the subscriber detecting a presence of at least one of a common pilot channel or a common synchronization channel by correlating simultaneously received transmission signals with known pseudo-random sequences to determine whether the channels exist. The common pilot channel and the common synchronization channel are included within 3G signals, and detecting their presence indicates the existence of 3G wireless coverage.

An exemplary WiMAX standard includes OFDMA (orthogonal-frequency-duplex multiple-access) symbols for transmission. Subscriber units that generate OFMDA signal transmission typically include FFT (fast fourier transform) circuitry. Therefore, WiMAX capable subscriber units have the FFT circuitry. For one embodiment, the subscriber detecting the 3G network availability using WiMAX processing FFT circuitry to perform de-spreading of 3G wireless signals and receive 3G broadcast samples. The de-spreading of 3G wireless signals is described later.

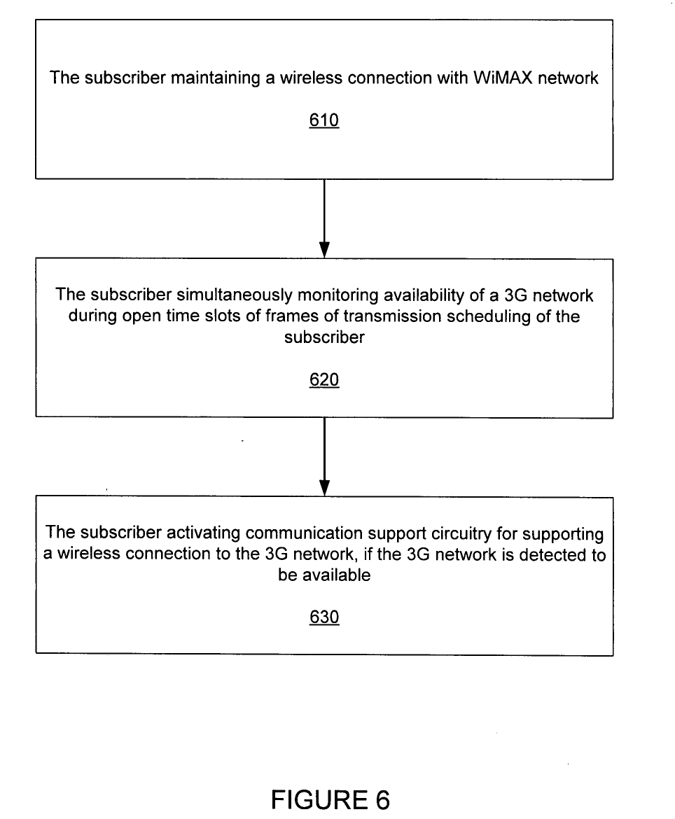

FIG. 6 is a flow chart showing steps of one example of a method of a subscriber unit managing wireless hand-off from a WiMAX network to a 3G network. A first step 610 of the method includes the subscriber maintaining a wireless connection with WiMAX network. A second step 620 includes the subscriber simultaneously monitoring availability of a 3G network during open time slots of frames of transmission scheduling of the subscriber. A third step 630 includes the subscriber activating communication support circuitry for supporting a wireless connection to the 3G network, if the 3G network is detected to be available.

As previously described, during open time slots the subscriber can detect a presence of at least one of a common pilot channel or a common synchronization channel by correlating simultaneously received transmission signals with known pseudo-random sequences to determine whether the channels exist.

Another embodiment includes the subscriber detecting a presence of a GSM broadcast channel during open time slots. More generally, the broadcast channel of any other wireless network can be monitored.

In a typical WiMAX system, the subscriber can issue a scan request. During the scan request, the subscriber can measure other network base station signals at different transmission channel frequencies. During the scanning period, the subscriber can detect the presence of, for example, a 3G network.

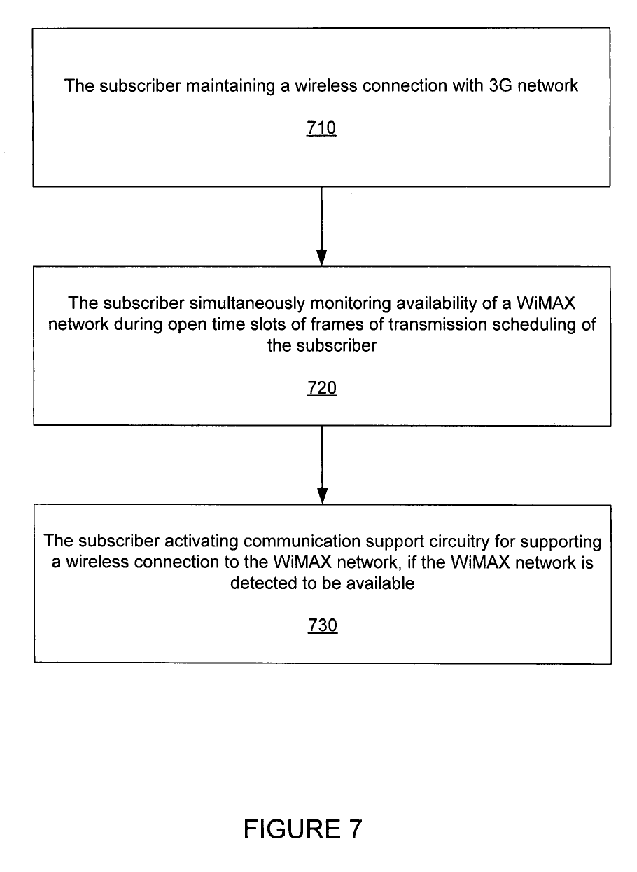

FIG. 7 is a flow chart that includes steps of an example of a method of a subscriber unit managing wireless hand-off from a 3G network to a WiMAX network. A first step 710 of the method includes the subscriber maintaining a wireless connection with 3G network. A second step 720 includes the subscriber simultaneously monitoring availability of a WiMAX network during open time slots of frames of transmission scheduling of the subscriber. A third step 730 includes the subscriber activating communication support circuitry for supporting a wireless connection to the WiMAX network, if the WiMAX network is detected to be available.

The subscriber may condition connection to the WiMAX network based upon whether, for example, the transmission signals of the wireless connection with the 3G network include voice or data communication. That is, if the transmission signals are voice communication, the subscriber may determine it is better to maintain its connection with the 3G wireless network. However, if the transmission signals are determined to be data communications, the subscriber may determine that it is better to switch to a connection with the WiMAX wireless network.

As previously described, the subscriber can simultaneously monitor availability of a second wireless network during open time slots of frames of transmission scheduling of the subscriber, when instructed to schedule according to a compressed mode frame.

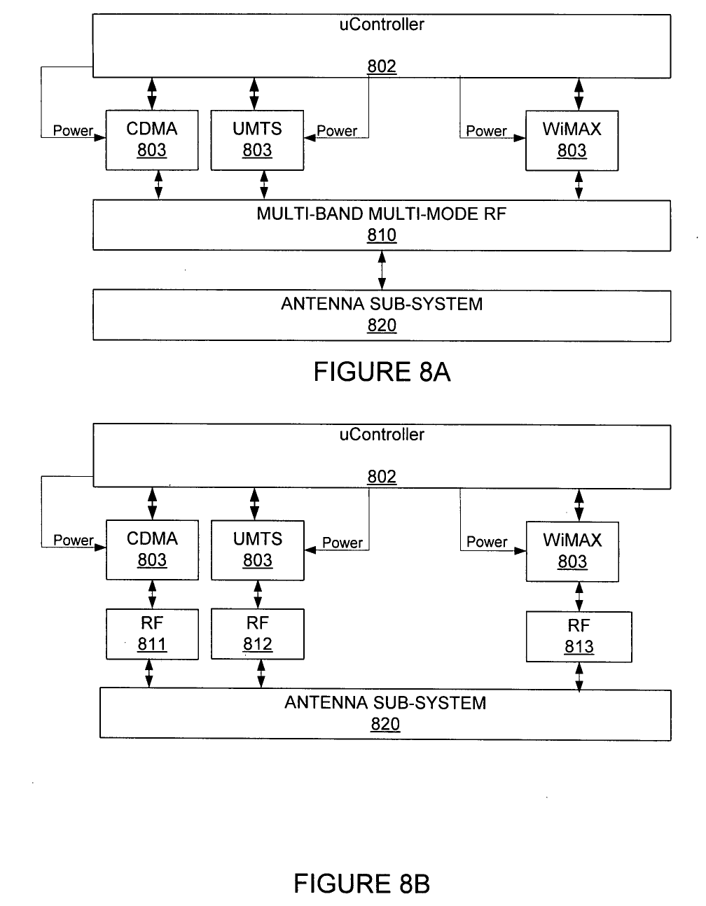

FIG. 8A shows an embodiment of receiver front-end circuitry of a multiple network subscriber. For this embodiment, the subscriber unit receives transmission signals of the first wireless network and the second wireless network through common antennas 820 and frequency filtering and down conversion circuitry 810.

A controller 802 provides management of the subscriber. The management can include, for example, the powering up and down of the processing circuitry required to support each of the different types of wireless networks. The processing circuitry can include, for example, CDMA circuitry 803, UMTS circuitry 803 and WiMAX circuitry 803. As described, for an embodiment, the processing circuitry for each of the different types of wireless networks is powered only when the subscriber is communicating with a corresponding network, or when checking the availability of the corresponding network while the subscriber is communicating with another network. Also, as described, when checking availability, the corresponding circuitry is powered during time gaps in the frames, or during the time gaps and during uplink transmission of the subscriber. This configuration provides for simultaneous monitoring availability of one network, while communicating with another, without requiring constant power to electronic circuitry needed to support communication with the different types of networks.

FIG. 8B shows another embodiment of receiver front-end circuitry of a multiple network subscriber. For this embodiment, the subscriber unit receives transmission signals of the first wireless network and the second wireless network through the antennas (can be multiple antennas) 820, but through separate frequency filtering and down conversion circuitry 811, 812, 813. The frequency filtering and down conversion is generally performed better in this embodiment than the embodiment of FIG. 8A because the circuitry can be specifically designed for the transmission channel of each of the different networks.

An embodiment includes the subscriber units shown in FIGS. 8A, 8B implemented on a single integrated circuit. A single integrated circuit embodiment provides a compact integrated circuit that can be utilized by a subscriber.

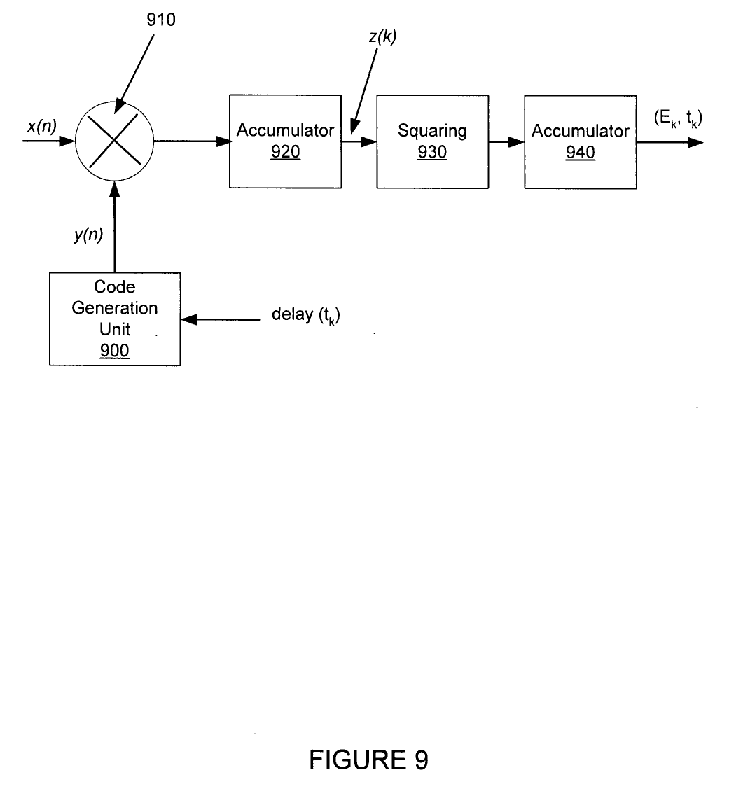

FIG. 9 shows an embodiment of receive signal correlation circuitry within a multiple network subscriber. As previously mentioned, during the open time slots, signals from the second network are received. The received signals can be correlated with known pseudo-random sequences to verify that the received signals are from, for example, a 3G wireless network. The receive signal correlation circuitry includes a code generation unit 900 that generates codes corresponding to, for example, 3G CDMA signals. The codes of the code generation unit 900 are multiplied with a receive signal at a multiplier 910. The result is accumulated by an accumulator 920 (also referred to as a coherent averaging block), squared (by a squaring operational unit 930) and again accumulated at an accumulator 940 (also referred to as a non-coherent averaging block). The output results in energy that can be detected if a network corresponding with the codes of the code generation unit 900 are sensed, indicating the presence of the network. If the detected energy (Eₖ, tₖ) is greater than a threshold, a network is detected.

The receive signal correlation circuitry of FIG. 9 provides despreading of a received signal. The first part of the correlation circuitry includes the coherent averaging block 920 where the correlation is carried out. After the coherent averaging block 920 there is a squared operation 930 followed by the non-coherent averaging block 940. The coherent and non-coherent averaging blocks can be generalized as N and M (where N and M are the respective averaging durations), respectively. When monitoring the other network over the TTG+UL+RTG time spans, the 6581 chips can be broken up into M=6 non-coherent groups each N=1024 chips as the coherent averaging block. For the embodiment in which only the TTG is used for monitoring, the coherent block can be set to N=465, and more WiMAX frames are needed to collect more non-coherent blocks. Note that the signal-to-noise ratio due to despreading increases by 3 dB per doubling of the coherent averaging block. That is, the SNR grows as 10 log₁₀ (N). Similarly, the SNR increases by 2 dB per doubling of the non-coherent averaging block, M Therefore, when the RTG gap is used for network detection, then N can set to 618 and M can be to set to 4, thereby providing an SNR high enough to properly detect the code, and requiring 4 WiMAX frames. Note that channel estimation is not required during the entire process of searching for the 3G BTS, since only energy detection is used (non-coherent processing). Both the input data and the PN code are complex-valued.

Generally, the correlator performs the following operations,

$$z ( k ) = {\sum }_{n = 0}^{N - 1} x ( n ) {y}^{*} ( n + k ) , 0 \leq k \leq N - 1$$

where x(n) denotes in the input samples and y(n) denotes the pseudo-random binary code at a given lag k. Here, the code is shifted by k. In other embodiments include the same functionality, but the input data is shifted. However both of these implementations are equivalent. Note that cross-correlation shown in FIG. 9 is a time-reverse conjugate convolution. As is well known, multiplication in the frequency domain is equivalent to convolution in time domain. Also, a square conjugate in the frequency domain is the time reversal and conjugation in the time domain. The correlation can be performed by taking an FFT of the input x(n) yielding F(n), taking the FFT of the code y(n) yielding G(n), and performing a point by point product F(n) multiplied by the conjugate(G(n)), and then performing an IFFT of the result.

Standard WiMAX systems include multi-carrier signals, more specifically, OFDM signals. The processing of OFDM signals require FFT circuitry. The FFT circuitry as used by WiMAX support circuitry can be used to perform the correlation function needed for detection of an CDMA pilot signal using the correlation detection method described.

Although specific embodiments of the invention have been described and illustrated, the invention is not to be limited to the specific forms or arrangements of parts so described and illustrated. The invention is limited only by the appended claims.

What is claimed:

1. A method of managing a subscriber handoff between types of wireless networks, comprising:
the subscriber maintaining a wireless connection with a first wireless network;
the subscriber simultaneously monitoring availability of a second wireless network during open time slots of frames of transmission scheduling of the subscriber;
the subscriber activating communication support circuitry for supporting a wireless connection to the second wireless network, if the second wireless network is detected to be available.

2. The method of claim 1, wherein the first wireless network is a WiMAX network and the second wireless network is a 3G network.

3. The method of claim 1, wherein the first wireless network is a 3G network and the second wireless network is a WiMAX network.

4. The method of claim 2, further comprising:
the subscriber determining whether transmission signals of the wireless connection with the WiMAX network includes voice or data communication;
if the transmission signals are voice communication, then the subscriber activating communication support circuitry for supporting a wireless connection to the 3G network, if the 3G network is detected to be available.

5. The method of claim 2, further comprising the subscriber detecting the 3G network availability using WiMAX processing FFT circuitry to perform de-spreading of 3G wireless signals and receive 3G broadcast samples.

6. The method of claim 5, further comprising the subscriber activating 3G processing circuitry if the subscriber unit detects 3G network availability.

7. The method of claim 3, further comprising:
the subscriber determining whether transmission signals of the wireless connection with the 3G network include voice or data communication;
if the transmission signals are data communication, then the subscriber activating communication support circuitry for supporting a wireless connection to the WiMAX network, if the WiMAX network is detected to be available.

8. The method of claim 3, further comprising the subscriber simultaneously monitoring availability of a second wireless network during open time slots of frames of transmission scheduling of the subscriber, when instructed to schedule according to a compressed mode frame.

9. The method of claim 1, further comprising the subscriber unit receiving transmission signals of the first wireless network and the second wireless network through common antennas and frequency down conversion circuitry.

10. The method of claim 1, further comprising the subscriber unit receiving transmission signals of the first wireless network and the second wireless network through separate antennas and separate frequency down conversion circuitry.

11. The method of claim 1, further comprising simultaneously monitoring availability of the second wireless network during an uplink sub-frame.

12. A method of a subscriber unit managing wireless hand-off from a WiMAX network to a 3G network, comprising:
the subscriber maintaining a wireless connection with WiMAX network;
the subscriber simultaneously monitoring availability of a 3G network during open time slots of frames of transmission scheduling of the subscriber;
the subscriber activating communication support circuitry for supporting a wireless connection to the 3G network, if the 3G network is detected to be available.

13. The method of claim 12, further comprising:
the subscriber determining whether transmission signals of the wireless connection with the WiMAX network includes voice or data communication;
if the transmission signals are voice communication, then the subscriber activating communication support circuitry for supporting a wireless connection to the 3G network, if the 3G network is detected to be available.

14. The method of claim 12, further comprising the subscriber detecting 3G network availability using WiMAX processing FFT circuitry to perform de-spreading of 3G wireless signals and receive 3G broadcast samples.

15. The method of claim 14, further comprising the subscriber activating 3G processing circuitry if the subscriber unit detects 3G network availability.

16. The method of claim 12, wherein the open time slots correspond with scan requests, allowing the subscriber to scan availability of the second wireless network.

17. The method of claim 12, wherein during open time slots the subscriber detects a presence of at least one of a common pilot channel or a common synchronization channel by correlating simultaneously received transmission signals with known pseudo-random sequences to determine whether the channels exist.

18. The method of claim 12, wherein during open time slots the subscriber detects a presence of a GSM broadcast channel.

19. A method of a subscriber unit managing wireless hand-off from a 3G network to a WiMAX network, comprising:
the subscriber maintaining a wireless connection with 3G network;
the subscriber simultaneously monitoring availability of a WiMAX network during open time slots of frames of transmission scheduling of the subscriber;
the subscriber activating communication support circuitry for supporting a wireless connection to the WiMAX network, if the WiMAX network is detected to be available.

20. The method of claim 19, further comprising:
the subscriber determining whether transmission signals of the wireless connection with the 3G network include voice or data communication;
if the transmission signals are data communication, then the subscriber activating communication support circuitry for supporting a wireless connection to the WiMAX network, if the WiMAX network is detected to be available.

21. The method of claim 19, further comprising the subscriber simultaneously monitoring availability of a second wireless network during open time slots of frames of transmission scheduling of the subscriber, when instructed to schedule according to a compressed mode frame.
